(19) United States
(12) Patent Application Publication
(10) Pub. No.: US 2022/0157126 A1
(43) Pub. Date: May 19, 2022

(54) METHOD, SYSTEM, AND ELECTRONIC DEVICE FOR CONDUCTING A PLAYER-BANKED DOMINOES WAGERING GAME

(71) Applicant: 305 GAMING LLC, Lake Worth, FL (US)

(72) Inventor: Brian Birkenmeyer, Lake Worth, FL (US)

(73) Assignee: 305 GAMING LLC, Lake Worth, FL (US)

(21) Appl. No.: 17/526,522

(22) Filed: Nov. 15, 2021

Related U.S. Application Data
(60) Provisional application No. 63/114,847, filed on Nov. 17, 2020.

(51) Int. Cl. G07F 17/32; A63F 9/20; G06Q 50/34; G06Q 30/00

(52) U.S. Cl. CPC G07F 17/3286; G07F 17/3213; G07F 17/3258; G07F 17/3276; G06Q 50/26; G07F 17/322; A63F 9/20; G06Q 50/34; G06Q 30/018; G07F 17/3269

(57) ABSTRACT

A computer-implemented method of administering a player-banked dominoes wagering game on a computer user interface depicting a specialized gaming table and having the steps of providing an electronic depiction of a specialized domino playing table, providing an electronic depiction of at least one specialized set of randomly ordered dominoes tiles each with varying ranks and in accordance with gaming regulations in various gaming jurisdictions, receiving a wager from a plurality of players participating in a player-banked dominoes game to have a wager pot, distributing a domino from randomly ordered domino tiles to a domino playing surface that is shared by all of the plurality of players participating in the player-banked domino game, and determining if the domino played by each player is a valid play according to the game rules, and if so allowing, if not disallowing the domino to be placed in the line of play.

### FIELD OF THE INVENTION

The present invention relates generally to gaming methods, systems, and electronic table devices, and, more particularly, relates to a player-banked dominoes wagering game, utilizing a specialized electronic table and method of commercial use for land-based and online casinos.

### BACKGROUND OF THE INVENTION

Gaming users and gaming operators are continually searching for fun, versatile, and profitable gaming methods and systems. Those known methods and systems mostly utilizing playing cards, dice, and roulette wheels to carry out the game. Although dominoes is a widely known game to many, casino operators fail to provide a commercial use dominoes wagering game to gaming users. Therefore, a need exists to overcome the problems with the prior art as discussed above.

### SUMMARY OF THE INVENTION

The invention provides a specialized method, system, and electronic table for conducting a player-banked dominoes wagering game that overcomes the hereinafore-mentioned disadvantages of the heretofore-known devices, systems, and methods of this general type and that provides users a high level of excitement for users and profitability for operators.

Although the invention is illustrated and described herein as embodied in a method, system, and electronic table for conducting a player-banked dominoes game, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

As used herein, the term “player-banked” is defined as a game with players wagering against each other, as opposed to betting against the casino or the house. The term “house-banked” is a wager against the casino or a pay table with a mathematical house advantage. “Dominoes” means a player-banked, tile-based game played with rectangular “domino” tiles. “Tile” means rectangular domino with a line dividing its face into two square ends. Each end of the tile may be marked with a number between 0 and 9. “Complete set of dominoes” means all 55 unique tiles, featuring all combinations of spot counts between 0 and 9, in a double-nine set of dominoes, in another example a complete set of double-six contains 28 unique tiles featuring all combinations of spot counts between 0 and 6. “Stock,” or sometimes referred to as “the boneyard,” means the group of tiles left over after all players have drawn their original tiles to start the round. “Button” means a circular object moved clockwise around a dominoes table to denote the assigned dealer for each hand. “Ante” means a predetermined wager that each player is required to make before each round begins. “Side Wager” is an optional house-banked wager in connection with the base game. “Buy a tile” a predetermined amount a player must pay to draw a tile from the stock, in the event they are unable to lay a tile or extend the line of play. “Round” means a complete cycle of a dominoes game. The round begins with the first tile being played and the round ends when a player lays all the tiles in their hand or when none of the players at the table can match a tile to the line of play. “Buy-in” means the amount of money required by the cardroom operator to enter and participate in a dominoes game. “Chips or tokens” means a money substitute, redeemable for cash, issued and sold by a cardroom operator for use in cardroom games. “Designated player” means the player identified by the button as the player in the dealer position. “Drop Box” means a virtual container designated to collect the rake or house commission. “Casino” means the cardroom, pari-mutual facility, land-based or online casino. “Game” means the completion of all betting rounds and final determination of a winner based upon the happening of a player playing all their tiles or in the event the game is blocked, the player with the lowest value of the sum of their tiles. “Hand” means the group of dominoes dealt to a player in a game. “Progressive Jackpot” means an accumulation of money collected from the dominoes game to be awarded to a player or players under certain preset conditions. “Pot” means the total amount wagered in a game of dominoes. “Proposition player” means a player who is employed by a cardroom operator, but who uses his own money to initiate or play in games. “Re-buy” means the additional chips purchased by players according to the schedule of re-buys prominently displayed in the facility. “Round of play” means, for any game of dominoes, the process by which dominoes are dealt, bets are placed and the winner is determined and paid in according to house rules and procedures. “Shill” means a player in a game provided by or employed by a cardroom operator who only bets with money provided by the cardroom operator. “Showdown” means the point in a dominoes game in which all hands are fully revealed to all other players and the hand with the lowest value becomes the winner. “Tip box” means a physical and/or virtual container into which all dealer tips are deposited.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a top plan view of a front side of a specialized domino tile utilized with the player-banked dominoes wagering game in accordance with one embodiment of the present invention;

FIG. 2 is a top plan view of a front side of another specialized domino tile utilized with the player-banked dominoes wagering game in accordance with another embodiment of the present invention;

FIG. 3 is a top plan view of a rear side of a specialized domino tile utilized with the player-banked dominoes wagering game in accordance with another embodiment of the present invention;

FIG. 4 is a top plan view of a specialized table surface utilized with a player-banked dominoes wagering game in accordance with an embodiment of the present invention;

FIG. 5 is a perspective view of a specialized electronic table utilized with a player-banked dominoes wagering game in accordance with an embodiment of the present invention; and

FIG. 6 is a top plan view of an electronic device depicting a user interface for a computerized device carrying out a computer-implemented player-banked dominoes wagering game in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

In one exemplary embodiment of the present invention is a commercial casino use dominoes game carried out on an electronic table game device.

The figures show several advantageous features of the present invention, but, as will be described below, the invention can be provided in several shapes, sizes, combinations of features and components, and varying numbers and functions of the components. In addition, the methods and systems described can be administered or carried out on many different devices including but not limited to an electronic table game inside a land-based casino or online on a mobile phone, tablet, or computer device. In some embodiments of the described invention, the method and system may be administered by a trained and licensed casino game dealer on an felt-top dominoes table surface.

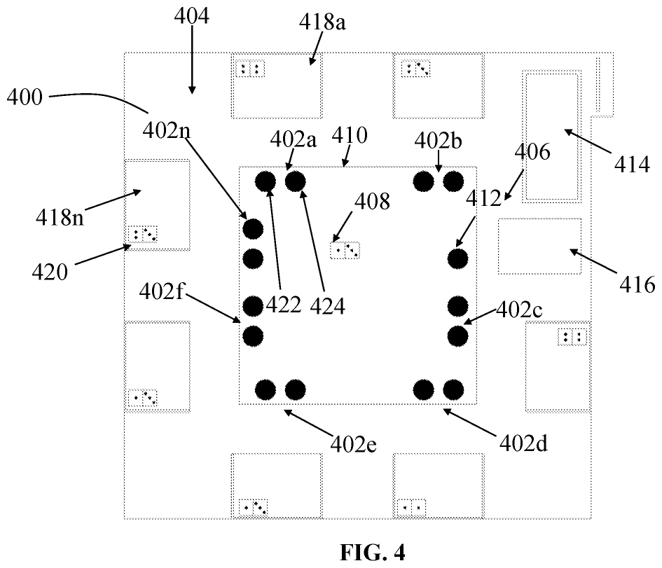

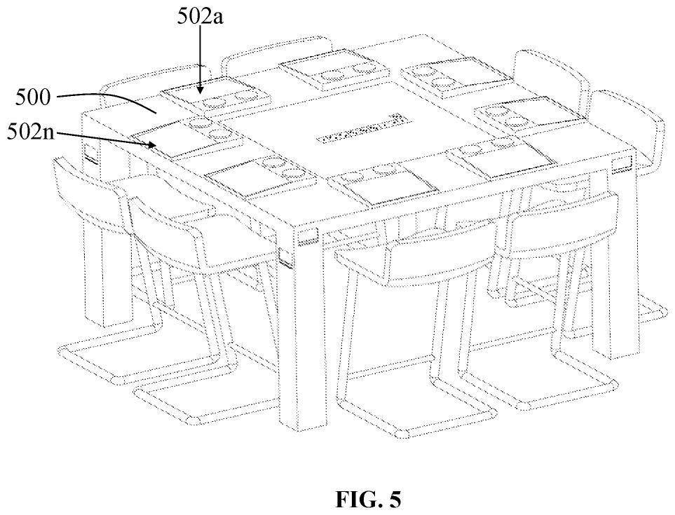

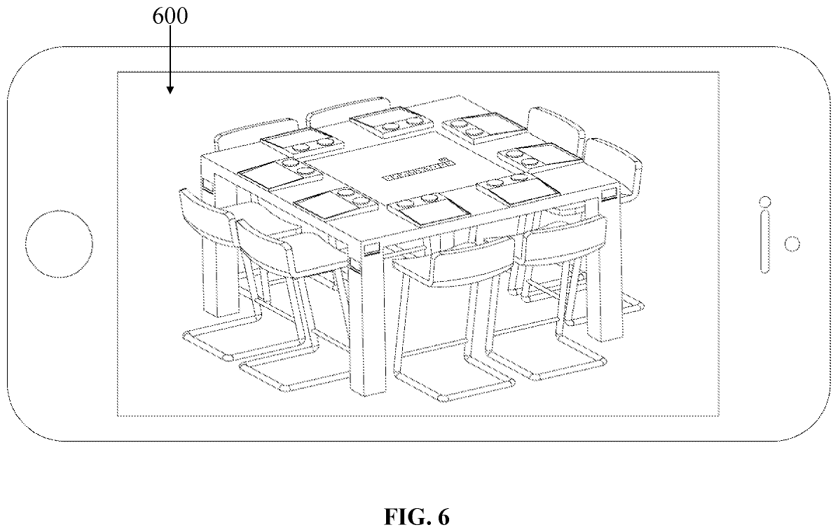

The present invention provides a novel and efficient method for administering a player-banked dominoes game. Referring now to FIGS. 4-6, embodiments of a specialized physical, electrical, and virtual dominos table are depicted. More specifically, the table 400 may include a plurality of seats associated with a plurality of player positions 402a-n (wherein “n” represents any number greater than one) demarcated on a table surface 404. The table 500 depicted in FIG. 5 may include a plurality of electronic displays 502a-n for use by a user and the virtual table 600 depicted on the user interface in FIG. 6 may also include one or more icons for utilization by the user.

The specialized dominoes table used in connection with the present invention may be square-shaped to effectuate placement of a plurality of users, or of another an oblong, polygonal, or circular shape. Using the table 400 in FIG. 4 as an example, the table 400 contains seven player positions 402a-n and one dealer position 406, for a total of eight positions at the table. On three sides of the square table are two player seats, and the fourth side of the square table will contain one player seat and one dealer seat.

The table surface layout and/or design may include a domino-sized rectangular marking 408 in the exact middle of the table 500, indicating where the first domino of each round will be placed. There will be another larger square marking 410 indicating the inside boundaries of the “line of play” whereas players must place all “in-play” domino tiles inside the square marking 410. The same square inner-boundary marking will be also be used by the dealer, to randomly shuffle the tiles before each round of play begins. The dominoes table will also include a chip-sized, designated rake circle 412, where dealer will place the chips that were raked from the wagering pot. The rake circle 412 will be located in-front of the dealer chip tray 414. Similarly, the virtual dealer chip tray and dominoes rack are also located in-front of the dealer seat position. The drop box 416 will preferably be attached to the table, at the dealers left or right. Each player position will have a rack 418a-n for their physical or digital dominoes tiles (e.g., tiles 420). In one embodiment, the racks 418a-n include a lower support flange that protrudes from a support back member extending upwardly therefrom. The racks 418a-n may also include a base support that may form a plane with the table surface. Each player position will have a wager circle where players will place their ante wagers and second wager circle disposed adjacent thereto where players may place the optional house-banked side bet.

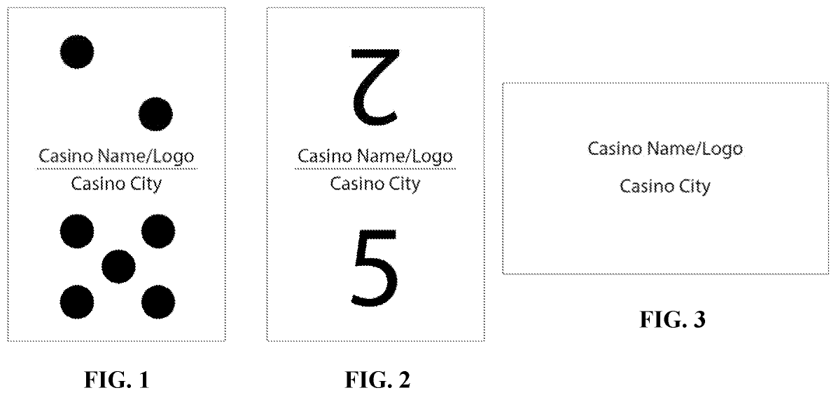

With Reference to FIGS. 1-3, exemplary physical or digital domino tiles used in connection with utilizing the present invention are depicted. The present invention may use a double-nine set of dominoes containing a total of 55 tiles in the complete set. The tiles are specially designed for commercial casino and cardroom use in regard to, game protection and surveillance. The specialized color scheme and design contains a white or ivory colored tile. The two numbers on the tiles will be numerals of 0-9, as opposed to a certain number of spots, dots, or pips. One of the numbers will be in large red font, the other number on the tile printed in large black font. The line dividing the dominoes in half will be in green font. The name of the casino or cardroom property will be printed in small green font on one side of the green divider line, the and the City where the property is located will be printed on the other side of the green divider line. The back side of the dominoes will have the property logo and/or property name and city.

In general, the present invention provides a method, systems and electronic table used to conduct a player-banked dominoes game that overcomes the disadvantages of the heretofore-known methods and devices of this general type. The invention describes a method and system for a player-banked dominoes game wherein, the ranking of tiles and hands includes each tile having two numbers, wherein each of the two numbers has respective values ranging from 0-9, with 10 unique numerical values. The sum of the two numbers on each tile are referred to the rank or weight of the tile, a “heavier” tile has a higher numerical value than a “lighter” tile that has a lower numerical value. The goal of the game is to be the first player to play all their tiles or have the lowest or lightest hand if the game is blocked and ends.

The invention describes a method and system for a player-banked dominoes game wherein, the betting scheme and rules for all wagers include each round of dominoes beginning with each player placing a mandatory “ante” wager in one of the portions on the card table surface, e.g., ante section 422. During the round of play, and in the event a player is “blocked” that player may be required to buy a domino from the dealer for an amount equal to 50% of the original “Ante” wager. For example, if the Ante is $10, it would cost $5 to buy a domino. In other embodiments, the player would “knock” and pass their turn to the next player.

The invention describes a method and system for a player-banked dominoes game wherein, the dealer or game administrator procedures include the following: 1. Before the game begins the game administrator will verify that each player has placed the mandatory Ante wager and/or any optional side bets (placed in the section 424); 2. To begin the game, dealer will count and verify there are 55 tiles or a complete set of double-nine domino tiles, containing all combinations of values between 0 and 9. Game administrator will randomly shuffle the dominoes face-down in the middle of the table, in order to create a random draw by players, ungrouping the tiles from the round before. Each player will draw one domino from the middle of the table and turn over revealing the value. The player with the highest domino gets the dealer button. The button will move in a clockwise rotation before each new round of play; 3. To begin each round, beginning with the player to the immediate left of the button, dealer will deal seven of the randomly shuffled tiles to each player. The player to the immediate left of the button will lay the first domino of the round; 4. Administrator will assist players when necessary throughout the round in organizing dominoes in the line of play in efforts to keep the line of play clear and correct. Dealer will also ensure the correct play of dominoes is happening according to house rules and procedures and disallow play of a domino tile that does not match the line of play; 5. In the event a player does not have a domino to play, the dealer will sell players dominoes from the stock or in some embodiments automatically skip that player and pass the turn to the next player; and 6. At the end of the game, dealer will confirm the 1^{st} place winner and 2^{nd} place runner-up of the dominoes round and pay each player accordingly.

Additionally, the invention describes a method and system for a player-banked dominoes game wherein, the round of play procedures include the following: 1. To begin the round, each player must make the mandatory Ante wager and/or any optional side wager; 2. The player to the left of the button starts the round by placing a tile in the center of the table (generally their highest double or heaviest tile); 3. In a clockwise rotation, the next player must match a domino to the either of the numerical values of the two square ends of the first domino played; 4. Each player then takes turns in a clockwise rotation, matching numbers where each match has a side of the same number count. A match is made as long as one end of the domino has a matching value and the player desires to make the match; 5. In the event, a player is unable to make a match, or “extend the line of play”, then they are required to buy a tile from the stock. In some embodiments, if the player cannot match a tile to the line of play, the turn goes to the next player; 6. The game continues until a player manages to play all of his/her hand of tiles (winner). The runner-up (2^{nd} place) is determined by the player who has the lowest value of dominoes, according to the sum of all the tiles in their hand when the winner is determined; and 7. If no plays can be made by any player and/or the stock is depleted, the 1^{st} place winner and 2^{nd} place runner up is determined by the player who has the lowest value of dominoes and the second lowest value, according to the sum of all the tiles in their hand.

In addition to the mandatory Ante wager, some embodiments of the described invention will offer players optional house-banked side wager(s) in connection with the player-banked base game of dominoes. This adds additional benefit for both operators and players of the game by adding additional action for players and additional profit for operators. The house edge on the house-banked side bet is an additional revenue stream combined with the rake on the player-banked base game of dominoes. Some exemplary side wager payouts would be based on the original tiles drawn by each player to start the base game. Some exemplary ways to win the side bet may include, at least a 1-to-1 payout, based on a certain preset over/under value on the sum of all tiles in the player's original hand. Another exemplary side bet would pay odds of at least 2-to-1 based on the draw of any certain tile in the set, i.e. the double-zero tile or the double-nine tile. Another exemplary side bet may include a certain preset combination of the tiles drawn i.e. making a 3 tile straight, 5 tile straight, or a 7 tile straight. An example of a 3 tile straight would be 4:4, 4:5, 4:6.

The invention describes a method and system for a player-banked dominoes game wherein, the rake amounts and procedures may include deducting, by a game administrator, at least one of a percentage or a flat fee amount from the wager pot as a rake or commission. Rake amounts and procedures may vary by casino property and/or gaming jurisdiction.

The method may also include either a percentage and/or a flat fee amount deducted from the wager pot that at least partially funds a progressive jackpot. The progressive jackpot can be funded by the player-banked wager pot in the base game and/or by the house-banked side bet wager pot. The triggering event causes the jackpot payout to occur may be from an event in the base game or the side game. The progressive jackpot may be linked to any number of other participating progressive tables within the network.

With reference to FIG. 5, one exemplary embodiment of the described invention may include an electronic table game ETG version inside a land-based casino setting. Whereas the ETG provides a simulation of the live table game version of the dominoes game. One of the major advantages of the ETG embodiment is that a live dealer is not required to deal the game, saving the casino money in payroll and dealer training related expenses. This is especially important since the described invention is a player-banked game and therefore there is no mathematical house edge, and the casino only makes a profit from the rake or commission. By eliminating a live dealer, the casino can therefore offer a lower rake on the game, a feature important to players.

Some versions of the present invention include features designed to speed up the game, a feature beneficial to operator profitability and players. In one example, the game controller would highlight or suggest which dominoes, in the players hand, are playable making it easier and faster for players to identify their possible plays, in addition the game controller could potentially make the play for the player if a player has not made a decision withing a certain amount of time or before a preset countdown timer is expired. If the player only has one possible play, the game controller would automatically make the play for the player. If the player has more than one possible play, the game controller may select a random tile in the players hand to play or in some embodiments the game controller could use AI artificial intelligence to detect the best option of play for the player the using basic game strategy the heaviest matching tile or a tile that would block another player from being able to go.

The described player-banked dominoes wagering game can be played in a variety of formats. For example, one preferred embodiment for online play of the player-banked dominoes game would be a fast-play sit-and-go format. Other examples of the described invention may include cash games, play money or social games, and tournament style format.

As seen in the figures, the method may first include providing at least one set of randomly ordered dominoes tiles. In computer-implemented and electronic table game versions of the present invention, the dominoes will be digital versions of physical dominoes tiles, randomly ordered using a random number generator and a specialized electronic dominoes table will be a digital version of the physical domino table. With reference to FIG. 6, a computer-implemented method of providing a player-banked dominoes game on a computer user interface providing a non-transitory memory resident on a computing device having a processor and operably coupled to an electronic user interface. The processor is operably configured to carry out a gaming method that includes receiving a wager from a plurality of players participating in a player-banked dominoes game to have a wager pot, wherein the plurality of players communicatively coupled together over a network, e.g., a WAN network or over the Internet.

Similar to the above-described method utilized for physical gaming, the computer-implemented method may include receiving a wager from a plurality of players participating in a player-banked dominoes game to have a wager pot, the plurality of players communicatively coupled together over a network. The game controller dealing at least two dominoes tiles from the at least one set of randomly ordered digital dominoes tiles to the plurality of players and displaying the digital dominos on the electronic display device or digital table surface. The user interface coupled to the electronic display device.

When the present invention is carried out by a computer processing system, the data processing system may be a symmetric multiprocessor (SMP) system including a plurality of processors connected to system bus. Alternatively, a single processor system may be employed. Also, connected to system bus is memory controller/cache, which provides an interface to local memory. An I/O bus bridge is connected to system bus and provides an interface to I/O bus. The memory controller/cache and I/O bus bridge may be integrated as depicted. The processor in conjunction with memory controller controls what data is stored in memory. The processor and memory controller can serve as a data counter for counting the rate of data flow to the memory or from the memory and can also count the total volume of data accessed to or from the memory, which is non-transitory. The processor can also work in conjunction with any other memory device or storage location. A peripheral component interconnect (PCI) bus bridge may also be connected to I/O bus provides an interface to PCI local bus. A number of modems, or wireless cards, may be connected to PCI bus. Typical PCI bus implementations will support four PCI expansion slots or add-in connectors. PCI includes, but is not necessarily limited to, PCI-X and PCI Express components.

Electrical and/or communications links may be utilized in the present invention, namely the electronic and digital/virtual implementations of the present invention, to power source(s) and/or a network. For example, a casino server, which may be resident in the United States or abroad, and the plurality of input devices may include connections, which are the medium used to provide communications links between various devices and computers connected together within the system or network. The connections may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention. In the depicted example, the network can include the Internet, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network also may be implemented as a number of different types of networks, such as for example, an Intranet, a local area network (LAN), or a wide area network (WAN). The system described herein and/or the network may include additional servers and other devices and entities not shown.

Computer programs (also called computer control logic) are stored in memory such as main memory, removable storage drive, removable media, hard disk, and signals. Such computer programs, when executed, enable the computer system to perform the features of the present invention as discussed herein. In particular, the computer programs, when executed, cause the processor and/or to perform the features of the simultaneous website and mobile app creation system. In certain embodiments, the computer program may carry out the timing and “reveal” portions of the above-described method.

In one embodiment, the system permits the plurality of input devices to communicate with a server and/or a display, as described herein. Embodiments of the system are configured such that the server may monitor the input of the plurality of input devices, provide the timing in which a player has to decide to participate in the dominoes hand and/or notify players of the time deadline to make such a decision and/or convey who is participating in said player-banked dominoes game.

The device utilized to cause the electronic display 600 to display the player's indication to play may include a user-input interface, a transceiver to communicate with other components at the table, and/or be electro-mechanical. A user interface as described herein functions to provide a user a method of providing input to the input device of the player's selection. In other embodiments, the input device may be mechanically activated and/or electro-manically activated. In preferred embodiments, the input device will only have a single input, thereby facilitating in quick and easy understanding of how the user is to input their selection. The user interface may also be a keypad providing a variety of user input operations. The user interface may include keys, buttons, and/or keypads that may be implemented as a touchscreen associated with the input device or display associated with each particular input device. The touchscreen may also provide output or feedback to the user, such as haptic feedback or orientation adjustments of the keypad according to sensor signals received by motion detectors, such as an accelerometer, located within the device.

The network interfaces of the devices may include one or more network interface cards (NIC) or a network controller. In some embodiments, the network interface may include a personal area network (PAN) interface. The PAN interface may provide the capability for the input devices to network using a short-range communication protocol, for example, a Bluetooth communication protocol. The PAN interface may permit the input devices to connect wirelessly to another electronic device via a peer-to-peer connection. The network interfaces may also include a local area network (LAN) interface. The LAN interface may be, for example, an interface to a wireless LAN, such as a Wi-Fi network. In one embodiment, there is a wireless LAN that provides the input devices with access to the Internet for receiving and sending inputs/messages to the server, over the Internet. The range of the LAN interface may generally exceed the range available via the PAN interface. Typically, a connection between two electronic devices via the LAN interface may involve communication through a network router or other intermediary device. Additionally, the network interfaces may include the capability to connect to a wide area network (WAN) via a WAN interface. The WAN interface may permit a connection to a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

Memory associated with the input devices may be, for example, one or more buffer, a flash memory, or non-volatile memory, such as random-access memory (RAM). The input devices may also include non-volatile storage. The non-volatile storage may represent any suitable storage medium, such as a hard disk drive or non-volatile memory, such as flash memory. The processing device can be, for example, a central processing unit (CPU), a microcontroller, or a micro processing device, including a “general purpose” micro processing device or a special purpose micro processing device. The processing device executes code stored in memory in order to carry out operation/instructions of the input devices, e.g., to display or communicate the player's selection in the dominoes game after receiving the player's input of the same. The processing device may provide the processing capability to execute an operating system, run various applications, such as the website/app editing application interface, communicate with one or more microcontrollers, and provide processing for one or more of the techniques and process steps described herein.

The display 600 displays information to the user such as the player's selection/decision (as described above), a timer, progressive jackpot, table limits, game rules, and the like. The display may be used to present various images, text, graphics, or videos to the user. The display may be any type of suitable display, such as a liquid-crystal display (LCD), a plasma display, a light-emitting diode (LED) display, or the like. The input devices may include audio input and output structures, such as a microphone for receiving audio signals from a user, e.g., of their selection, and/or a speaker for outputting audio data, such as audio-visual alerts of the player's selection and/or of the timing deadline to make said selection received by the input devices over a network, and the like.

The described method and process may be carried out by a plurality of electronic devices including but not limited to, a virtual table game in a gaming establishment or online over a network (e.g., using the Internet), or an electronic/slot machine style game in a gaming establishment and/or electronic table game. Moreover, the present invention can also be carried out online over network or offline using a desktop computer, mobile device, tablet, a smartphone, or any other electronic processing device with or without wireless or LAN capabilities.

The steps of the present invention, which are explained in more detail above, can be embodied in a computer program that is executable by one of the above-described processors, that may be on (e.g., communicatively coupled to) a video gaming machine. Computer programs (also called computer control logic) are stored in memory such as main memory, removable storage drive, removable media, hard disk, and signals. Such computer programs, when executed, enable the computer system to perform the features of the present invention as discussed herein. In particular, the computer programs, when executed, enable the processor to perform the steps of the present invention.

As such, the video gaming machine implemented with carrying out the above-described steps may include a computing means, e.g., a processor, and a storing means, e.g., a memory. The processor is operable to run one or more programs/applications and interfaces associated with the video gaming machine or stored on the memory in order to effectuate the data transfer and communications required by the present invention. The video gaming machine may also have other components or features that may include an image capturing element, lights, multiple displays, or other transducers.

In one software embodiment, the program may be designed to API interface or be added onto an existing online casino platform. This advantageous embodiment will allow for easier installation across multiple different platforms such as different online casinos that offer real money gambling games and free to play or social games.

In other exemplary embodiments whereas the electronic device is not present for any reason, the method and process may be carried out by a professionally trained and/or licensed casino game dealer. The dealer, preferably being employed by the gaming establishment and trained to deal the game in accordance with the house rules and procedures. The dealer performing some of the same game functions as the electronic device does in other exemplary embodiments of the described invention.

Although a specific order of executing the process steps, the order of executing the steps may be changed relative to the order shown in certain embodiments. Also, two or more steps described as occurring in succession may be executed concurrently or with partial concurrence in some embodiments. Certain steps may also be omitted for the sake of brevity. In some embodiments, some or all of the process steps can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A computer-implemented method of administering a player-banked dominoes wagering game on a computer user interface depicting a specialized gaming table comprising the steps of:
providing a non-transitory memory resident on a computing device having a processor and operably coupled to an electronic user interface, the processor operably configured to carry out a gaming method that includes:
providing an electronic depiction of a specialized domino playing table in accordance with gaming regulations in various gaming jurisdictions;
providing an electronic depiction of at least one specialized set of randomly ordered dominoes tiles each with varying ranks and the tiles in accordance with gaming regulations in various gaming jurisdictions; and
receiving a wager from a plurality of players participating in a player-banked dominoes game to have a wager pot, the plurality of players communicatively coupled together over a network, wherein the wager is approved by and in accordance with gaming regulations in various gaming jurisdictions; and
distributing, with a game controller, at least one domino from the at least one set of randomly ordered domino tiles to the domino playing surface that is shared by all of the plurality of players participating in the player-banked domino game; and
determining, with a game controller, if the domino played by each player is a valid play according to the game rules, and if so allowing, if not disallowing the domino to be placed in the line of play.

2. The computer-implemented method according to claim 1, wherein:
the game controller determines and verifies a winner in the player-banked dominoes game upon the occurrence of the first player to play all the tiles in their hand or in the event the game is blocked.

3. The computer-implemented method according to claim 1, further comprising:
determining and verifying a winner by comparing the total sum value of the remaining tiles in each players hand, the winner dictated by a player with the lowest value.

4. The computer-implemented method according to claim 1, further comprising:
evaluating remaining tiles for the plurality of players participating in the player-banked dominoes game to ascertain a winning player hand of one of the plurality of players participating in the player-banked dominoes game based on a lowest value hand hierarchy, the winning player hand entitling the winning player to at least a portion of the wager pot.

5. The computer-implemented method according to claim 1, further comprising:
deducting, by a game administrator, at least one of a percentage or a flat fee amount from the wager pot as a rake or a commission;
distributing at least a portion of the wager pot to the at least on winner of the player-banked dominoes game; and
resetting play, with the game controller, for a new round of play.

6. The computer-implemented method according to claim 5, further comprising:
at least partially funding, from the at least one of a percentage or a flat fee amount deducted from the wager pot, a progressive jackpot visually depicted on the electronic display device.

7. The computer-implemented method according to claim 1, further comprising:
determining a winner of the house-banked side bet and corresponding payout from the pay table based upon a preset unique value or combination of tiles originally drawn by each player to begin the round.

8. The computer-implemented method according to claim 1, further comprising:
initiating, after the start of each players turn to act, a timer visually depicted on the electronic display, the timer having a predetermined timing event caused by the passage of a period of time; a players failure to play a tile before the expiration of predetermined time event; and
modulating, at the expiration of the period of time, the game controller auto-playing a dominoes tile from the player's hand.

9. The computer-implemented method according to claim 1, wherein:
the electronic table game in a land-based gaming environment.

10. The computer-implemented method according to claim 1, wherein:
the method is implemented over an electronic display of a mobile phone and/or personal computing device.

11. The computer-implemented method according to claim 1, wherein:
the player-banked dominoes game is administered by a trained live dealer.

12. The computer-implemented method according to claim 1, wherein:
the aforementioned method is tested by an independent test lab to ensure compliance and game integrity in a certain gaming jurisdiction.

13. A method of administering a player-banked dominoes wagering game on a specialized table, the method comprising the steps of:
providing at least one set of randomly ordered dominoes tiles with varying hierarchal ranks;
providing a domino playing table with:
at least one leg having a support surface; and
a domino playing surface positioned above the support surface;
providing at least one trained and licensed casino game administrator;
receiving a wager from a plurality of players participating in a player-banked dominoes game to have a wager pot;
shuffling, by the game administrator, the set of dominoes into a random order;
distributing at least one domino from the at least one set of randomly ordered dominoes to the plurality of players participating in the player-banked dominoes game, at least one of the plurality of players participating in the dominoes game, playing or placing a domino tile in the line of play on the playing surface;
determining, by the game administrator, if the domino placed in the line of play by each player is a valid play in accordance of the game rules, and if so allowing that domino to be placed into the line of play, if not disallowing the domino to be placed in the line of play; and
determining and verifying, by the game administrator, a winner in the player-banked dominoes wagering game, wherein the winner is determined by the first player participating in the game to place all their dominoes tiles in the line of play or, if the game is blocked, and no player can place a tile, comparing the total sum value of the remaining tiles in each players hand based on a lowest value hand hierarchy, the winning player hand entitling the winning player to at least a portion of the wager pot.

14. The computer-implemented method according to claim 13, further comprising:
deducting, by the game administrator, at least one of a percentage or a flat fee amount from the wager pot as a rake or commission; the rake or commission approved by and in accordance with gaming regulations in various gaming jurisdictions; and
distributing, by the game administrator, at least a portion of the wager pot to the at least one winner of the player-banked dominoes game.

15. The computer-implemented method according to claim 13, wherein:
the at least one of a percentage or a flat fee amount deducted from the wager pot at least partially funds a progressive jackpot visually depicted on an electronic display device.

16. The computer-implemented method according to claim 13, wherein:
an optional house-banked side bet is administered in connection with the base game of player-banked dominoes and then determining a winner of the house-banked side bet and corresponding payout from the pay table based upon a preset unique value or combination of tiles originally obtained by each player to begin the round.

17. The computer-implemented method according to claim 13, wherein:
the method of game play certified by an independent gaming test lab to ensure compliance and game integrity in a certain gaming jurisdiction.
